(19) United States
(12) Patent Application Publication
(10) Pub. No.: US 2026/0072776 A1
(43) Pub. Date: Mar. 12, 2026

(54) DETECTING AND ISOLATING CLIENT APPLICATION ANOMALIES

(71) Applicant: Lenovo (United States) Inc., Morrisville, NC (US)

(72) Inventors: Matthew Fardig, Boonville, IN (US); Travis Ennis, Jasper, IN (US); Joshua Smith, Milton, FL (US); Leana Neparidze, San Francisco, CA (US)

(21) Appl. No.: 18/826,742

(22) Filed: Sep. 6, 2024

(51) Int. Cl. G06F 11/07; G06F 11/36

(52) U.S. Cl. CPC G06F 11/079; G06F 11/3672; G06F 2201/865

(57) ABSTRACT

A method for detecting and isolating client application anomalies includes detecting an abnormal situation occurring in a software and determining, a set of abnormal clients and a set of normal clients in response to detecting the abnormal situation occurring in the software. The method includes comparing one or more client characteristics of the set of abnormal clients with one or more client characteristics of the set of normal clients and determining one or more client-side anomalies based, at least in part, on the comparison.

### FIELD

The subject matter disclosed herein relates to client application anomalies and more particularly relates to detecting and isolating client application anomalies.

### BACKGROUND

When customers seek support from a software vendor, the vendor may struggle to debug issues originating in the customer's network due to limited visibility. This often requires relying on potentially inaccurate information from the customer or requesting remote access, which some customers may decline due to privacy concerns. These challenges can lead to a negative perception of the software.

### BRIEF SUMMARY

A method for detecting and isolating client application anomalies is disclosed. An apparatus and computer program product also perform the functions of the method. The method includes detecting an abnormal situation occurring in a software and determining, a set of abnormal clients and a set of normal clients in response to detecting the abnormal situation occurring in the software. The method includes comparing one or more client characteristics of the set of abnormal clients with one or more client characteristics of the set of normal clients and determining one or more client-side anomalies based, at least in part, on the comparison.

According to another aspect of the present disclosure, an apparatus for detecting and isolating client application anomalies is disclosed. The apparatus may include a processor and non-transitory computer readable storage media storing code. The code may be executable by the processor to perform operations that include detecting an abnormal situation occurring in a software and determining, a set of abnormal clients and a set of normal clients in response to detecting the abnormal situation occurring in the software. The operations include comparing one or more client characteristics of the set of abnormal clients with one or more client characteristics of the set of normal clients and determining one or more client-side anomalies based, at least in part, on the comparison.

According to another aspect of the present disclosure, a program product for detecting and isolating client application anomalies is disclosed. The program product may include a non-transitory computer readable storage medium storing code. The code may be configured to be executable by a processor to perform operations that include detecting an abnormal situation occurring in a software and determining, a set of abnormal clients and a set of normal clients in response to detecting the abnormal situation occurring in the software. The operations include comparing one or more client characteristics of the set of abnormal clients with one or more client characteristics of the set of normal clients and determining one or more client-side anomalies based, at least in part, on the comparison.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for detecting and isolating client application anomalies, according to various embodiments.

FIG. 2 is a schematic block diagram illustrating an apparatus for detecting and isolating client application anomalies, according to various embodiments.

FIG. 3 is a schematic block diagram illustrating another apparatus for detecting and isolating client application anomalies, according to various embodiments.

FIG. 4 is a schematic block diagram illustrating another apparatus for detecting and isolating client application anomalies, according to various embodiments.

FIG. 5 is a sequence diagram illustrating another system for detecting and isolating client application anomalies, according to various embodiments.

FIG. 6 is a schematic flow chart diagram illustrating a method for detecting and isolating client application anomalies, according to various embodiments.

FIG. 7 is a schematic flow chart diagram illustrating another method for detecting and isolating client application anomalies, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the "C" programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

A method for detecting and isolating client application anomalies is disclosed. An apparatus and computer program product also perform the functions of the method. The method includes detecting an abnormal situation occurring in a software and determining, a set of abnormal clients and a set of normal clients in response to detecting the abnormal situation occurring in the software. The method includes comparing one or more client characteristics of the set of abnormal clients with one or more client characteristics of the set of normal clients and determining one or more client-side anomalies based, at least in part, on the comparison.

In some embodiments, the method includes pre-processing one or more metrics to define a norm and determining if a currently measured one or more metrics is falling outside the norm to detect the abnormal situation occurring in the software. In some embodiments, pre-processing the one or more metrics includes adjusting for seasonality in the one or more metrics and normalizing the one or more metrics.

In some embodiments, the method includes gathering contextual information based on the abnormal situation in response to detecting the abnormal situation occurring in the software, the contextual information including information related to a respective client application. In some embodiments, the method includes isolating a group of clients based on the contextual information and determining, from the group of clients, the set of abnormal clients and the set of normal clients. In some embodiments, the method includes selecting one or more types of contextual information to be gathered based on a software attribute or a software characterization. In some embodiments, the method includes determining a root cause of the abnormal situation based on the contextual information.

In some embodiments, the determining the set of abnormal clients includes identifying, from the group of clients, a first set of clients which are experiencing an issue associated with the abnormal situation, and wherein determining the set of normal clients includes identifying, from the group of clients, a second set of clients which are not experiencing the issue.

In some embodiments, determining the one or more client-side anomalies includes producing a list of differences between the one or more client characteristics of the set of abnormal clients and the one or more client characteristics of the set of normal clients.

In some embodiments, the method includes, in response to determining the set of abnormal clients and the set of normal clients, receiving the one or more client characteristics of the set of abnormal clients and the one or more client characteristics of the set of normal clients from the set of abnormal clients and the set of normal clients respectively.

In some embodiments, the method includes requesting the set of abnormal clients and the set of normal clients to send the one or more client characteristics of the set of abnormal clients and the one or more client characteristics of the set of normal clients respectively.

In some embodiments, the method includes receiving the one or more client characteristics of the set of abnormal clients from the set of abnormal clients during the abnormal situation and selecting the one or more client characteristics of the set of normal clients based, at least in part, on a set of client characteristics associated with the set of normal clients, wherein the set of client characteristics were received during a previously known working situation and recorded in a normal log.

An apparatus for detecting and isolating client application anomalies is disclosed. The apparatus may include at least one processor and at least one non-transitory computer readable storage medium storing code. The code is executable by the at least one processor to perform operations for detecting and isolating client application anomalies, including detecting an abnormal situation occurring in a software and determining, a set of abnormal clients and a set of normal clients in response to detecting the abnormal situation occurring in the software. The operations may include comparing one or more client characteristics of the set of abnormal clients with one or more client characteristics of the set of normal clients and determining one or more client-side anomalies based, at least in part, on the comparison.

In some embodiments, the operations include pre-processing one or more metrics to define a norm and determining if a currently measured one or more metrics is falling outside the norm to detect the abnormal situation occurring in the software. In some embodiments, pre-processing the one or more metrics includes adjusting for seasonality in the one or more metrics and normalizing the one or more metrics.

In some embodiments, the operations include gathering contextual information based on the abnormal situation in response to detecting the abnormal situation occurring in the software, the contextual information including information related to a respective client application. In some embodiments, the operations include isolating a group of clients based on the contextual information and determining, from the group of clients, the set of abnormal clients and the set of normal clients. In some embodiments, the operations include selecting one or more types of contextual information to be gathered based on a software attribute or a software characterization. In some embodiments, the operations include determining a root cause of the abnormal situation based on the contextual information.

In some embodiments, the determining the set of abnormal clients includes identifying, from the group of clients, a first set of clients which are experiencing an issue associated with the abnormal situation, and wherein determining the set of normal clients includes identifying, from the group of clients, a second set of clients which are not experiencing the issue.

In some embodiments, determining the one or more client-side anomalies includes producing a list of differences between the one or more client characteristics of the set of abnormal clients and the one or more client characteristics of the set of normal clients.

In some embodiments, the operations include, in response to determining the set of abnormal clients and the set of normal clients, receiving the one or more client characteristics of the set of abnormal clients and the one or more client characteristics of the set of normal clients from the set of abnormal clients and the set of normal clients respectively.

In some embodiments, the operations include requesting the set of abnormal clients and the set of normal clients to send the one or more client characteristics of the set of abnormal clients and the one or more client characteristics of the set of normal clients respectively.

In some embodiments, the operations include receiving the one or more client characteristics of the set of abnormal clients from the set of abnormal clients during the abnormal situation and selecting the one or more client characteristics of the set of normal clients based, at least in part, on a set of client characteristics associated with the set of normal clients, wherein the set of client characteristics were received during a previously known working situation and recorded in a normal log.

A program product for detecting and isolating client application anomalies includes a non-transitory computer readable storage medium storing code. The code is configured to be executable by a processor to perform operations that include detecting an abnormal situation occurring in a software and determining, a set of abnormal clients and a set of normal clients in response to detecting the abnormal situation occurring in the software. The operations include comparing one or more client characteristics of the set of abnormal clients with one or more client characteristics of the set of normal clients and determining one or more client-side anomalies based, at least in part, on the comparison. In some embodiments, the code may be configured to be executable by a processor to perform additional operations for detecting and isolating client application anomalies as described herein.

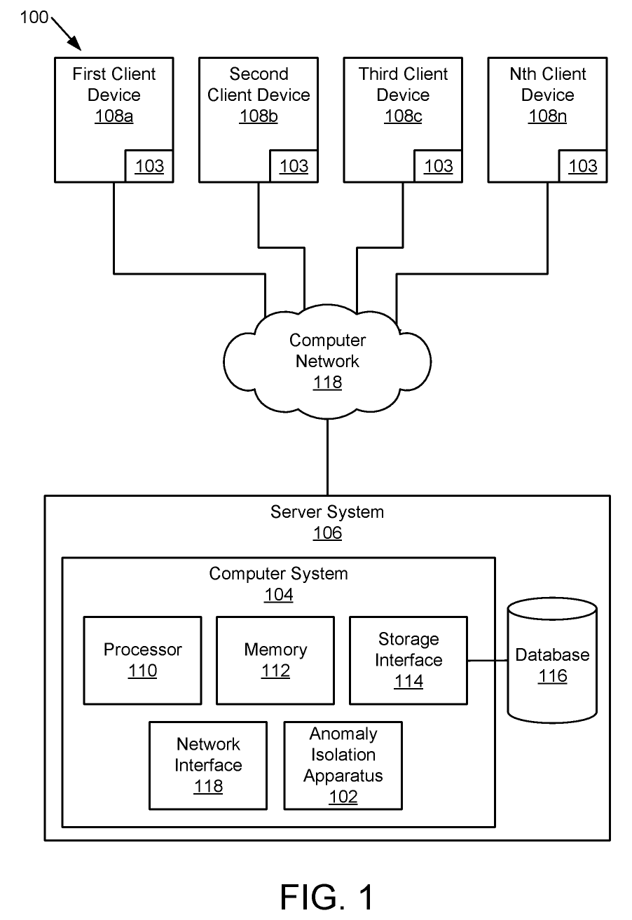

FIG. 1 is a schematic block diagram illustrating a system 100 for detecting and isolating client application anomalies, according to various embodiments. The system 100 includes an anomaly isolation module 102, a computer system 104, a server system 106, one or more client devices 108a-108n (collectively or generally “108”), a processor 110, a memory 112, a storage interface 114, a database 116, and a computer network 118.

When a customer calls a software vendor (e.g., a support engineer) asking for support, the software vendor reviews the cloud portion of their application for issues with the help of metrics, logs, etc. When the source of the issue is on the customer network, it is challenging for the software vendor to debug remotely as they have limited visibility on the events occurring in the customer’s network. Sometimes, to identify the cause of the issue, the software vendors ask questions to the customers based on best guesses hoping that the information provided by the customer is accurate. Some other times, when the customer fails to provide accurate information required for debug, the software vendors may request a client machine for remote access to identify the cause of the issue, but some customers may not be willing to allow an external person accessing the client machines as they may have sensitive data on the client machines. Some other times, the software vendors request the network administrators for logs from the client to identify the cause of the issue. Such scenarios may lead to bad perception of the software by the customer.

The anomaly isolation module 102 enables an analyst or troubleshooter, such as the software vendor or the network administrator, to have a targeted view of an area where the issue could be occurring. For example, the anomaly isolation module 102 detects an abnormal situation occurring in the software and isolates the client application anomalies to enable the software vendor or the network administrator to focus their efforts on the area with the issue and resolve the issue.

In some embodiments, the anomaly isolation module 102 detects an abnormal situation occurring in a software and determines a set of abnormal clients (e.g. 108a-108b) and a set of normal clients (e.g. 108c-108d) in response to detecting the abnormal situation occurring in the software. In some embodiments the anomaly isolation module 102 compares one or more client characteristics of the set of abnormal clients (e.g. 108a-108b) with one or more client characteristics of the set of normal clients (e.g. 108c-108d) and determines one or more client-side anomalies based at least in part on the comparison.

In some embodiments, the anomaly isolation module 102 pre-processes one or more metrics to define a norm and determines if a currently measured one or more metrics is falling outside the norm to detect the abnormal situation occurring in the software. In some embodiments, pre-processing the one or more metrics includes adjusting for seasonality in the one or more metrics and normalizing the one or more metrics.

In some embodiments, seasonality may refer to predictable fluctuations or pattern in the metrics that recur at regular intervals within a particular time window (e.g., a week, a month or a year). The fluctuations or the pattern may relate to factors such as customer behavior, weather conditions, recurring events, or the like which causes the fluctuations or the pattern in the metrics. In some embodiments, adjusting for seasonality may refer to a technique used to remove the effects of the predictable patterns from the metrics to better define the normal situation. In some embodiments, normalizing may refer to adjusting the one or more metrics measured on different scales to a common scale for analysis or monitoring the metrics. In some embodiments, different types of normalization techniques such as min-max normalization, Z-score normalization, decimal scaling, linear scaling, or the like may be used.

In general, a seasonality adjustment algorithm may be applied to remove seasonal components from the time series. More specifically, the seasonal adjustment algorithm may be applied to analyze a trend and deviations from the trend of a time series independently of the seasonal components. In general, a time series is a series of data points (e.g., the metrics) indexed, listed or graphed in time order.

In some embodiments, the anomaly isolation module 102 selects a type of contextual information to be gathered based on a software attribute or a software characterization. In some embodiments the anomaly isolation module 102 gathers the selected type of contextual information based on the abnormal situation in response to detecting the abnormal situation occurring in the software. The contextual information, in some embodiments, includes information related to a respective client application. In some embodiments the anomaly isolation module 102 isolates a group of clients (e.g. 108a-108d) based on the contextual information and determines, from the group of clients (e.g. 108a-108d), the set of abnormal clients (e.g. 108a-108b) and the set of normal clients (e.g. 108c-108d).

In some embodiments, determining the set of abnormal clients (e.g. 108a-108b) includes identifying, from the group of clients (e.g. 108a-108d), a first set of clients (e.g. 108a-108b) which are experiencing an issue associated with the abnormal situation, and determining the set of normal clients (e.g. 108c-108d) includes identifying, from the group of clients (e.g. 108a-108d), a second set of clients (e.g. 108c-108d) which are not experiencing the issue. In some embodiments, the anomaly isolation module 102 determines a root cause of the abnormal situation based on the contextual information.

In some embodiments, the anomaly isolation module 102 produces a list of differences between the one or more client characteristics of the set of abnormal clients (e.g. 108a-108b) and the one or more client characteristics of the set of normal clients (e.g. 108c-108d). In some embodiments, the anomaly isolation module 102, in response to determining the set of abnormal clients (e.g. 108a-108b) and the set of normal clients (e.g. 108c-108d), receiving the one or more client characteristics of the set of abnormal clients (e.g. 108a-108b) and the one or more client characteristics of the set of normal clients (e.g. 108c-108d) from the set of abnormal clients (e.g. 108a-108b) and the set of normal clients (e.g. 108c-108d) respectively.

In some embodiments, the anomaly isolation module 102 receives the one or more client characteristics of the set of abnormal clients (e.g. 108a-108b) from the set of abnormal clients (e.g. 108a-108b) during the abnormal situation and selects the one or more client characteristics of the set of normal clients (e.g. 108e-108f) based at least in part on a set of client characteristics associated with the set of normal clients (e.g. 108e-108f), wherein the set of client characteristics were received during a previously known working situation and recorded in a normal log.

The system 100 includes a server system 106 that includes the computer system 104 and the database 116. The computer system 104 includes the anomaly isolation module 102, at least one processor 110 to perform operations, the memory 112, the storage interface 114, and the network interface 118. The computer system 104 may further include, in general a non-volatile memory, communication busses, etc. It should be noted that the server system 106 as illustrated and hereinafter described is merely illustrative of an apparatus that could benefit from embodiments of the present disclosure and, therefore, should not be taken to limit the scope of the present disclosure. It should be noted that the server system 106 may include fewer or more components than those depicted in FIG. 1.

The computer system 104 may be for example, but not limited to, a server device, a tower server, a blade server, a rack-mounted server, desktop computers, or a workstation. The storage interface 114 enables the processor 110 to have access to the database 116. The storage interface 114 may be for example, but not limited to, an Advanced Technology Attachment (“ATA”) adapter, a Serial ATA (“SATA”) adapter, a Small Computer System Interface (“SCSI”) adapter, a RAID controller, a SAN adapter, a network adapter, and/or any component providing the processor 110 with access to the database 116. In various embodiments, the computer system 104 hosts a software (e.g., an application) for the client devices 108. The software, may be, for example, but not limited to, a web application, a desktop application, a mobile application, etc.

The system 100 includes client devices 108 that include a client module 103. The client devices 108 may be for example, but not limited to, a laptop, a tablet, a desktop, a mobile phone, a smartphone, and/or an E-reader. The client devices 108, in some embodiments, may include at least one user device that runs a software (e.g., a client application) and interacts with the server system 106 through the computer network 118. In various embodiments, the client devices 108 may be referred to as clients 108.

The client module 103, in some embodiment, may periodically send one or more metrics of the respective client devices 108 to the server system 106. In some embodiment, the client module 103 may send the one or more metrics of the respective client devices 108 to the server system 106 in response to receiving a request to send the one or more metrics. In some embodiment, the one or more metrics may be on or more snapshots of the respective client application and/or the respective client device 108. In some embodiments the one or more snapshots indicate the current state of the respective client application and/or the respective client device 108.

In some embodiments, the client module 103 may receive a request from the server system 106 to perform one or more client tests in the respective client device 108. The client module 103, in some embodiment, may perform one or more tests in response to receiving the request from the server system 106 to perform one or more client tests. In some embodiments, the client module 103 may send the client test results as the client characteristics to the server system 106.

The database 116, in some embodiments, may be a time-series database where analysis may be performed. The database 116 collects and stores one or more metrics of the client application and the client devices 108 which include, but not limited to, connection rate, error rate, message rate, and message size. In some embodiments, the database 116 may periodically receive from the client devices 108 the one or more metrics of the respective client application and/or the respective client device 108 running on the client devices 108. In other embodiments, the database 116 may send a request the client devices 108 to send the one or more metrics. In some embodiment, the database 116 may receive one or more snapshots of the respective client application and/or the client device 108 that include the one or more metrics.

In some embodiments the database 116 may be a cloud database that stores the one or more metrics on a remote database, which is hosted and managed by a third-party cloud service provider. In other embodiments, the database 116 may be a traditional database that stores the one or more metrics in a local server.

The computer network 118, in some embodiments, includes a LAN, a WAN, a fiber network, a wireless connection, the Internet, or the like. In some embodiments, the computer network 118 includes two or more networks. In some embodiments, the computer network 118 includes servers, wiring, switches, routers, etc.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

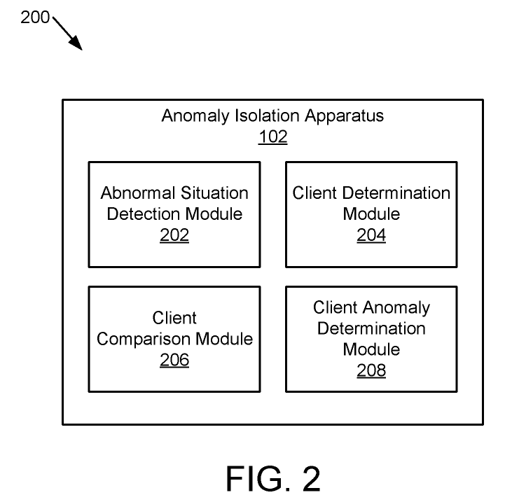

FIG. 2 is a schematic block diagram illustrating an apparatus 200 for detecting and isolating client application anomalies, according to various embodiments. The apparatus 200 includes an anomaly isolation module 102 that includes an abnormal situation detection module 202, client determination module 204, client comparison module 206, and client anomaly determination module 208. In some embodiments, the apparatus 200 is implemented using executable code stored on a computer readable storage device, which is non-transitory. The code is executable on a processor. In other embodiments, all or a portion of the apparatus 200 is implemented using a programmable hardware device and/or hardware circuits.

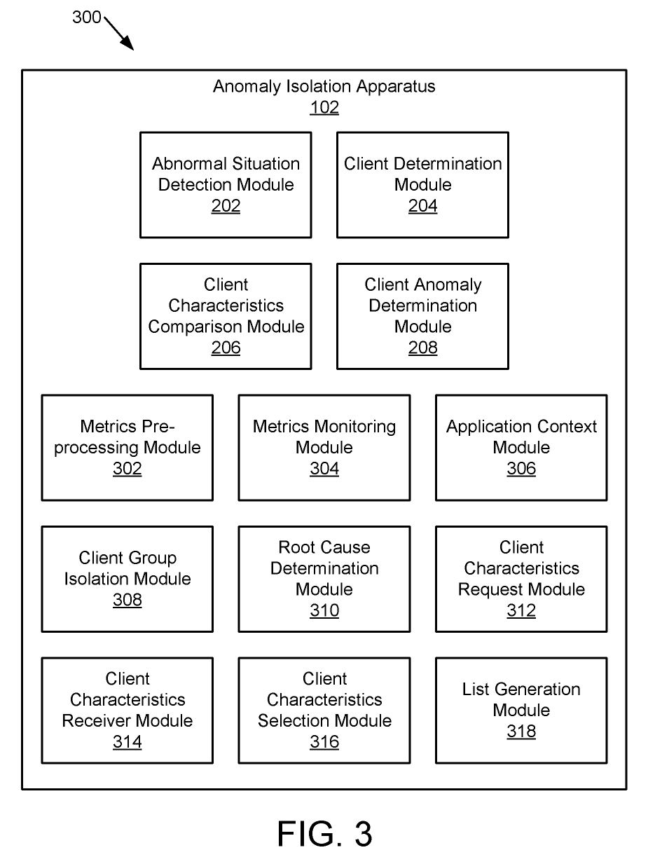

The apparatus 200 includes an abnormal situation detection module 202 configured to detect an abnormal situation occurring in the software. In some embodiments, the abnormal situation may refer to an event where the one or more metrics is falling outside the norm. In some embodiments, the abnormal situation may be an indication that one or more clients 108 are experiencing an issue. In some embodiments, the abnormal situation may be an indication that the one or more clients 108 are behaving abnormally. In some embodiments, the abnormal situation may be detected by using a metrics monitoring module 304 (e.g., as described below with reference to FIG. 3) that may continuously monitor the one or more metrics which may be periodically received from the one or more clients 108.

The abnormal situation detection module 202 pre-processes one or more metrics to define a norm. In some embodiments, pre-processing may refer to preparation and transformation of raw data (e.g., the one or more metrics) into a format suitable for training machine learning models. In some embodiments, the one or more metrics may refer to data points or quantifiable measures of connection rate, error rate, message rate, message size and/or the like.

In some embodiments, the abnormal situation detection module 202 may use a metrics pre-processing module (e.g., as described below with reference to FIG. 3) to pre-process one or more metrics to define the norm. In some embodiments the abnormal situation detection module 202 may access the database 116 to receive the one or more metrics. In some embodiments, the abnormal situation detection module 202, to pre-process the one or more metrics, may apply a seasonality adjust algorithm to the one or more metrics to adjust for the seasonality in the one or more metrics and then normalize the one or more metrics to define a norm. In some embodiments, the historical data (e.g., previously measured one or more metrics stored in a time-series database) may be used to define a norm. In some embodiments, the norm may refer to a reference point that indicates a normal situation in the respective client application and/or the client devices 108. For example, the norm may refer to a threshold value or a range, associated with the one or more metrics, which is used to compare with the one or more currently measured metrics of the client devices 108. In some embodiments, the abnormal situation detection module 202 may use one or more normalization techniques to define a norm.

In general, a seasonality adjustment algorithm may be applied to remove seasonal components from the time series. More specifically, the seasonal adjustment algorithm is applied to analyze a trend and deviations of a time series independently of the seasonal components. In some embodiments, the trend may be identified as the normal behavior of the client devices 108. In some embodiments, the values of the trend may be used to establish a reference point or a range (e.g., the norm) which is used to compare against the currently measure one or more metrics. In general, the time series is a series of data points (e.g., the metrics) indexed, listed or graphed in time order.

In some embodiments, the abnormal situation detection module 202 determines if a currently measured one or more metrics is falling outside the norm. For example, the abnormal situation detection module 202 determines if the currently measured value of the metrics does not lie between the define range or if the currently measured value of the metrics is crossing a threshold value or a reference point. In some embodiments, the abnormal situation detection module 202 may use a metrics monitoring module 304 (described in the description of FIG. 3) to continuously measure the one or more metrics. If the currently measured one or more metrics is falling outside the norm, the abnormal situation detection module 202 detects that an abnormal situation is occurring in the software. If the currently measured one or more metrics is not falling outside the norm, the abnormal situation detection module 202 continues to monitor the next measured one or more metrics to determine if the next measured one or more metrics is falling outside the norm.

The apparatus 200 includes a client determination module 204 configured to determine a set of abnormal clients (e.g., 108a-108b) and a set of normal clients (e.g., 108c-108d) in response to detecting the abnormal situation occurring in the software. In some embodiment, the client determination module 204 may gather contextual information related to the respective client application based on the abnormal situation in response to detecting the abnormal situation. In some embodiments, the client determination module 204 module may use the application context module 306 (described in the description of FIG. 3) to gather the contextual information.

In some embodiments, the client determination module 204 isolates a group of clients (e.g., 108a-108d) based on the contextual information and determines from the group of clients (e.g., 108a-108d), the set of abnormal clients (e.g., 108a-108b) and a set of normal clients (e.g., 108c-108d). In some embodiment, the client determination module 204 may select a type of contextual information to be gathered based on a software attribute or a software characterization and gathers the selected type of contextual information in response to detecting the abnormal situation. In some embodiments, for example, the client determination module 204 may use the client group isolation module 308 (described in the description of FIG. 3) to isolate the group of clients (e.g., 108a-108d). In some embodiment, a first set of clients (e.g., 108a-108b) experiencing an issue, the issue being associated with the abnormal situation, is identified as the set of abnormal clients (e.g., 108a-108b), and a second set of clients (e.g., 108c-108d) not experiencing the issue is identified as the set of normal clients (e.g., 108c-108d). In some embodiments, isolating the group of clients (e.g., 108a-108d) may advantageously reduce the number of clients to be examined.

In some embodiments, determining the set of abnormal clients (e.g., 108a-108b) includes identifying from the group of clients (e.g., 108a-108d), a first set of clients (e.g., 108a-108b) which are experiencing an issue associated with the abnormal situation. In some embodiments, determining the set of normal clients (e.g., 108c-108d) includes identifying from the group of clients (e.g., 108a-108d), a second set of clients (e.g., 108c-108d) which are not experiencing the issue.

The apparatus 200 includes a client comparison module 206 configured to compare one or more client characteristics of the set of abnormal clients (e.g., 108a-108b) with the one or more client characteristics of the set of normal clients (e.g., 108c-108d). In some embodiments, the client characteristics may be for example, results of the one or more client tests performed by the set of abnormal clients (e.g., 108a-108b) and the set of normal clients (e.g., 108c-108d) during the abnormal situation. In some embodiments, the one or more client tests may include, but not limited to, 1) ping tests to measure reachability of address, response time, etc., 2) port checks to verify that certain ports and/or protocols are allowed, 3) trace routes to trace a route to destination for example, an application endpoint in the cloud, and record all of the hops on the local network, the amount of time for each hop, etc., 4) Web Real-Time Communications (“WebRTC”) tests to record information such as candidates, candidate pairs, whether Traversal Using Relays around NAT (“TURN”) was used or not in the connection, error information during connections, etc. and/or 5) any other tests that can be launched, performed or measured from the isolated group of clients (e.g., 108a-108d).

In some embodiment, the client comparison module 206 may send one or more requests to perform and send one or more client tests the set of abnormal clients (e.g., 108a-108b) and the set of normal clients (e.g., 108c-108d).

In an embodiment, for example, if there are a set of abnormal clients (e.g., 108a-108d) and there are no normal clients based on a particular type of contextual information, then the client comparison module 206 may receive the client characteristics from the set of abnormal clients (e.g., 108a-108d) that are experiencing the issue and select the one or more client characteristics of a set of normal clients (e.g., 108c-108d) based at least in part on a set of client characteristics associated with the set of normal clients (e.g., 108c-108d), wherein the set of client characteristics were received during a previously known working situation and recorded in a log. For example, in a situation where an entire organization, and/or geographical region is experiencing an issue, client characteristics of the clients gathered during a previously known working situation (e.g., when the set of clients were normal) is used as the client characteristics of the set of normal clients (e.g., 108c-108d), for comparison.

The apparatus 200 includes a client anomaly determination module 208, configured to determine one or more client-side anomalies based at least in part on the comparison performed by the client comparison module 206. In some embodiments, the client anomaly determination module 208 may feed resulting data from the client comparison module 206 to an anomaly detection algorithm. The anomaly detection algorithm may be configured to produce a list of differences between the client characteristics of the set of abnormal clients (e.g., 108a-108b) and the client characteristics of the set of normal clients (e.g., 108c-108d). In some embodiments, the list of differences may be identified as a list of client anomalies. In some embodiments, the list of differences enables a user (e.g., a network administrator, a software vendor, or a support engineer) to have a targeted view of the client anomaly. For example, the list of differences isolates the areas of the network and/or behavior of the set of abnormal clients (e.g., 108a-108b) that should be reviewed by the user. In some embodiments, the list of client anomalies may be provided, over the computer network 118, to the user on an electronic device (e.g., a laptop, a tablet, a mobile phone, etc.). In other embodiment, the computer system 104 may include a display (not shown) and/or a user interface that enable the user to view the list of client anomalies and take actions.

In various embodiments, the list of anomalies enables the user (e.g., a network administrator, a software vendor, or a support engineer) to take actions based on the list of client anomalies, to resolve the issue occurring in the abnormal client devices (e.g., 108a-108b). In some embodiments, the list of client anomalies enables the user to resolve the issue immediately, before the customer decides to call the user (e.g., a network administrator, a software vendor, or a support engineer) for support. In some embodiments, the anomaly isolation module 102 may resolve one or more client anomalies in the list of anomalies based on a type of the issue and in some embodiments, the anomaly isolation module 102 may provide an indication to the user to take action on a remaining one or more client anomalies in the list of client anomalies to resolve the client anomalies. In some embodiments, the anomaly isolation apparatus may provide an indication to the user that the one or more anomalies were resolved by the anomaly isolation module 102 and may provide details of the actions taken to resolve the issue.

For example, in a classroom management software, if a student has an application (e.g., an anti-virus software) running in the background on his/her device, the anomaly isolation module 102 may send a pop-up notification to the student informing that the application which is running in the background needs to be closed. In another example, based on the type of issue, the pop-up notification may inform the student to restart his/her device.

In some embodiments, the anomaly isolation module 102 may automatically take actions, based on the type of issue. For example, if the issue that a student is experiencing related to bandwidth (i.e., the maximum amount of data that can be transmitted over a network in a give time), then the anomaly isolation module 102 may reduce the frame rate of the teacher’s screen being viewed by the student. In another example, if the issue is related to bandwidth, the anomaly isolation module 102 may disconnect the student from one or more services or one or more functionalities.

FIG. 3 is a schematic block diagram illustrating another apparatus 300 for detecting and isolating client application anomalies, according to various embodiments. The apparatus 300 includes the anomaly isolation module 102 that includes an abnormal situation detection module 202, a client determination module 204, a client comparison module 206, and a client anomaly determination module 208 which are substantially similar to those described above in relation the apparatus 200 of FIG. 2. In the implementation shown in FIG. 3, the anomaly isolation module 102 may additionally include, in various embodiments, one or more of: a metrics pre-processing module 302, a metrics monitoring module 304, an application context module 306, a client group isolation module 308, a root cause determination module 310, a client characteristics request module 312, a client characteristics receiver module 314, a client characteristics selection module 316, a list generation module 318, or any combination thereof. In various embodiments, all or a portion of the apparatus 300 is implemented similar to the apparatus 200 of FIG. 2. In some embodiments, the apparatus 300 is implemented using executable code stored on a computer readable storage device, which is non-transitory. The code is executable on a processor. In other embodiments, all or a portion of the apparatus 300 is implemented using a programmable hardware device and/or hardware circuits.

The apparatus 300 may include a metrics pre-processing module 302, configured to pre-process one or more metrics to define a norm. In some embodiments, pre-processing the one or metrics may refer to converting the one or more metrics into a series of observations, where each observation is represented as a feature vector. These observations are optionally labeled with its class, such as normal or abnormal. The feature vectors are then suitable as input to a server-side anomaly detection algorithm. The server-side anomaly detection algorithm may include one or more machine learning algorithms configured to detect an abnormal situation occurring in the software. In some embodiment, the metrics pre-processing module 302 may apply a seasonality adjustment algorithm to adjust to the seasonality in the one or more metrics and normalizing the one or more metrics to define a norm (e.g., a normal).

In some embodiments, the normal may be different for each customer, for example, in a classroom management software, when a teacher shares their screen with students in a virtual classroom, the expectation of normal is that the students will see the screen. However, if a school has a slower network, then students may experience a slower response time from the teacher than a school that has a faster network. In such a case, the definition of a normal response time will differ from customer to customer (e.g., school to school).

The apparatus 300 may include a metrics monitoring module 304, configured to determine if a currently measured one or more metrics is falling outside the norm. For example, the abnormal situation detection module 202 determines if the currently measured value of the metrics does not lie between the defined range or if the currently measured value of the metrics is crossing a threshold value or a reference point. In some embodiment, if the currently measured one or more metrics is falling outside the norm, the metrics monitoring module 304 may generate a trigger (e.g., a signal) that indicates the abnormal situation occurring in the software.

The apparatus 300 may include an application context module 306, configured to gather contextual information based on the abnormal situation in response to detecting the abnormal situation. In some embodiments, the contextual information may be gathered from one or more current metrics related to a client application that were received from the client devices 108. In some embodiments, the contextual information may be gathered from one or more snapshots of the client application that were received from the client devices 108. In some embodiments, the contextual information may be gathered from the results produced by the server-side anomaly detection algorithm during the abnormal situation. In some embodiment, the contextual information includes information related to a respective client application. For example, if the software is a classroom management software (e.g., LanSchool Air), the application context module 306 gathers contextual information that reveal 1) if the issue is occurring in a single classroom or a set of classroom, 2) if the issue is occurring in a single organization or multiple organization, 3) if the issue is occurring only at a particular time of day, and/or 4) if the organization have a mix of operating systems or client versions.

In some embodiments, the application context module 306 may select a type of contextual information to be gathered based on a software attribute or a software characterization. For example, if the software is related to a telecom industry, then the application context module 306 gathers a different type context information when compared to the example of the classroom management software above. The different type of contextual information may be information that reveals 1) if the issue is occurring in a single geographic region or multiple geographic regions.

In other embodiment, the application context module 306 may gather, based at least in part on the software attribute or the software characterization, another different type of contextual information. For example, the different type of contextual information may be client device characteristics such as client operating system type, client operating system level, run time, other software running on the client device 108 (e.g., virus software, firewalls, etc.) and/or the like. In other embodiments, the application context module 306 may gather, based at least in part, on the software attribute or the software characterization, another different type of contextual information such as a list of clients that connected to the server system 106 during a particular duration of time, for example, clients that connected during the last five days, the last five hours, five days ago and/or the like. In other embodiments, the application context module 306 may gather, based at least in part on the software attribute or software characteristics, another different type of contextual information for example, a list of clients that sent a certain number of thumbnails to the server system 106.

The apparatus 300 may include a client group isolation module 308, configured to isolate a group of clients (e.g., 108a-108d) based on a selected type of contextual information. For example, in some embodiments, the client group isolation module 308 isolates, based on the selected type of contextual information, a group of clients (e.g., 108a-108d) 1) from a single organization or multiple organizations, 2) from a single geographic region or multiple geographic regions, 3) that connected to the server during a particular time period (e.g., last five days, last five hours, five days ago and/or the like), 4) that sent a certain number of thumbnails to the server system 106, or 5) with certain client device characteristics such as client operating system type, client operating system level, run time, other software running on the client device 108 (e.g., virus software, firewalls, etc.).

In various embodiment, the client group isolation module 308 isolates a first set of clients (e.g., 108a-108b) that are experiencing an issue, the issue being associated with the abnormal situation, and a second set of clients (e.g., 108c-108d) that are not experiencing the issue. In various embodiments the client group isolation module 308 isolates the first set of clients (e.g., 108a-108b) and the second set of clients (e.g., 108c-108d) such that the first set of clients (e.g., 108a-108b) and the second set of clients (e.g., 108c-108d) have the same context. In some embodiment the first set of clients (e.g., 108a-108b) are identified as the set of abnormal clients (e.g., 108a-108b) and the second set of clients (e.g., 108c-108d) are identified as the set of normal clients (e.g., 108c-108d).

The apparatus 300 may include a root cause determination module 310, configured to determine the root cause of the abnormal situation based on the contextual information. For example, the root cause determination module 310 may identify the reason for the issue to be occurring. For example, the root cause determination module 310 may identify that the issue is occurring because the client devices 108 have a different operating system, the client devices 108 have a different operating system level, or the client devices have other software currently running. The root cause determination module 310, enables a support engineer to have knowledge of the root cause of the issue while performing debug operations.

The apparatus 300 may include a client characteristics request module 312, configured to send a request to each of the isolated group of clients (e.g., 108a-108d) to send the one or more client characteristics of each of the isolated group of clients (e.g., 108a-108d). In some embodiments, the client characteristics request module 312 may request the set of abnormal clients (e.g., 108a-108b) and the set of normal clients (e.g., 108c-108d) to send the one or more client characteristics of the set of abnormal clients (e.g., 108a-108b) and the one or more client characteristics of the set of normal clients (e.g., 108c-108d) respectively. In some embodiments, the request sent to the isolated group of clients includes a request to perform one or more client tests. In some embodiments, the one or more client tests may include, but not limited to, 1) ping tests to measure reachability of address, response time, etc., 2) port checks to verify that certain ports and/or protocols are allowed, 3) trace routes to trace a route to destination for example, an application endpoint in the cloud, and record all of the hops on the local network, the amount of time for each hop, etc., 4) Web Real-Time Communications (“WebRTC”) tests to record information such as candidates, candidate pairs, whether Traversal Using Relays around NAT (“TURN”) was used or not in the connection, error information during connections, etc. and/or 5) any other tests that can be launched, performed or measured from the isolated group of clients (e.g., 108a-108d).

The apparatus 300 may include a client characteristics receiver module 314, configured to receive the one or more client characteristics of the set of abnormal clients (e.g., 108a-108b) and the one or more client characteristics of the set of normal clients (e.g., 108c-108d).

The apparatus 300 may include a client characteristics selection module 316, configured to select the one or more client characteristics of the set of normal clients (e.g., 108c-108d) based at least in part on the set of client characteristics associated with the set of normal clients (e.g., 108c-108d), wherein the set of client characteristics were received during a previously known working situation and recorded in a log. For example, if there are a set of abnormal clients (e.g., 108a-108d) and there are no normal clients based on a particular type of contextual information, then the client characteristics selection module 316 may receive the client characteristics from the set of abnormal clients (e.g., 108a-108d) that are experiencing the issue and select the one or more client characteristics of a set of normal clients (e.g., 108c-108d) based at least in part on a set of client characteristics associated with the set of normal clients (e.g., 108c-108d), wherein the set of client characteristics were received during a previously known working situation and recorded in a log. For example, in a situation where an entire organization, and/or geographical region is experiencing an issue, client characteristics of the clients gathered during a previously known working situation (e.g., when the set of clients were normal) is used as the client characteristics of the set of normal clients (e.g., 108c-108d), for comparison.

The apparatus 300 may include a list generation module 318, configured to generate a list of differences between the one or more client characteristics of the set of abnormal clients (e.g., 108a-108b) and the one or more client characteristics of the set of normal clients (e.g., 108c-108d). In some embodiment, the generated list of differences may be identified as one or more client-side anomalies. The list generation module 318 enables a user to advantageously use the generated list of differences to have a targeted view of the issue and focus their efforts for debugging the one or more client-side anomalies.

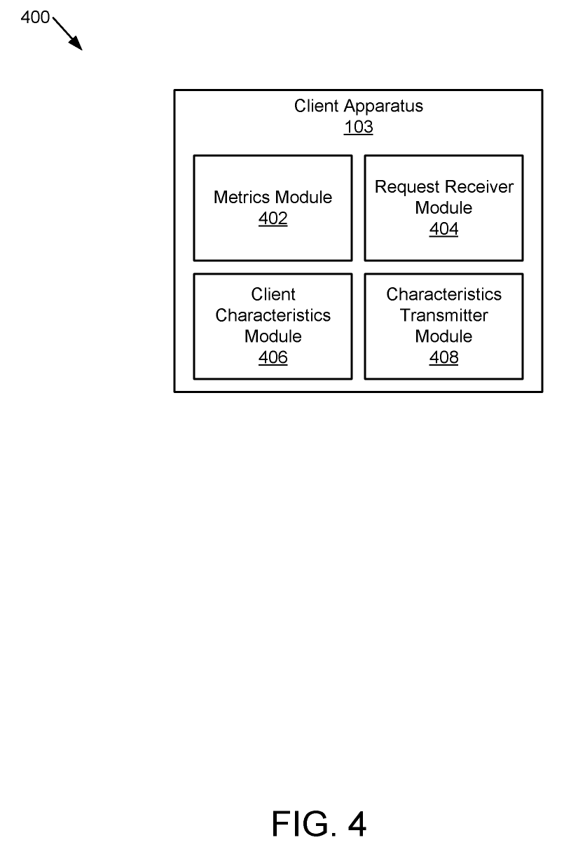

FIG. 4 is a schematic block diagram illustrating another apparatus 400 for detecting and isolating client application anomalies, according to various embodiments. The apparatus 400 includes client module 103 that includes a metrics module 402, a request receiver module 404, a client characteristics module 406, and a characteristics transmitter module 408. In some embodiments, the apparatus 400 is implemented using executable code stored on a computer readable storage device, which is non-transitory. The code is executable on a processor. In other embodiments, all or a portion of the apparatus 400 is implemented using a programmable hardware device and/or hardware circuits.

The apparatus 400 may includes a metrics module 402, configured to periodically send, from the respective client devices 108, one or more metrics to the server system 106. In some embodiments the metrics module 402 may receive one or more requests from the server system 106 to send the one or more metrics from the respective client devices 108.

The apparatus 400 may includes a request receiver module 404, configured to receive requests from the server system 106 to send the client characteristics of the respective client devices 108. In some embodiments, the requests may be requests to perform one or more client tests in the respective client devices 108. In some embodiments, the request receiver module 404 may trigger the client characteristics module 406 to determine one or more client characteristics in response to a received request.

The apparatus 400 may includes a client characteristics module 406, configured to determine one or more client characteristics of the respective client devices 108. In some embodiments, the client characteristics module 406 may perform one or more client tests to determine the client characteristics of the respective client devices 108.

The apparatus 400 may includes a characteristics transmitter module 408, configured to transmit a response message containing the one or more client characteristics to the server system 106, for example in response to the client characteristics module 406 determining the one or more characteristics of the respective client devices 108.

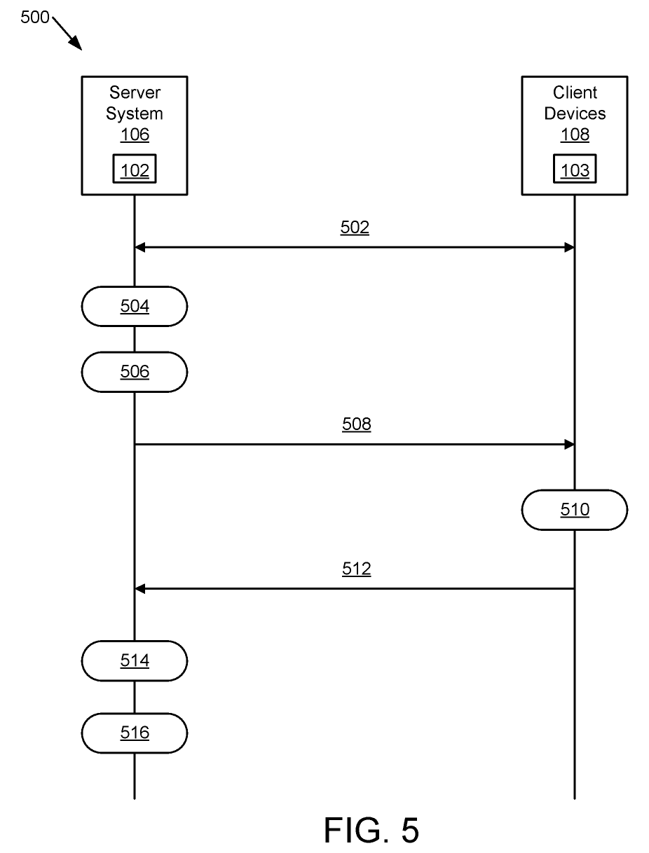

FIG. 5 is a sequence diagram illustrating another system 500 for detecting and isolating client application anomalies, according to various embodiments. The system 500 includes a server system 106 that includes an anomaly isolation module 102 and client devices 108 that each includes a client module 103. It should be noted that each of the communications described may include one or more messages.

In a first communication 502, the client device 108 may send one or more metrics periodically or in response to receiving a request to send the one or more metrics from the server system 106. In some embodiments, the anomaly isolation module 102 detects 504 an abnormal situation occurring in the software by monitoring the one or more metrics that were received from the client devices 108 and determining if the one or more metrics is falling outside a norm. In some embodiment, the anomaly isolation module 102 determines 506 a set of abnormal clients (e.g., 108a-108b) and a set of normal clients (e.g., 108c-108d) based on contextual information, in response to detecting the abnormal situation occurring in the software.

In a second communication 508, the anomaly isolation module 102 requests the set of abnormal clients (e.g., 108a-108b) and the set of normal clients (e.g., 108c-108d) to send one or more client characteristics of the set of abnormal clients (e.g., 108a-108b) and one or more characteristics of the set of normal clients (e.g., 108c-108d) respectively. In some embodiment, each of the set of abnormal clients (e.g., 108a-108b) and each of the set of normal clients (e.g., 108c-108d) may perform 510 one or more client tests to determine the one or more client characteristics of the respective client devices 108.

In a third communication 512, the client module 103 of each of the set of abnormal clients (e.g., 108a-108b) and the set of normal clients (e.g., 108c-108d) sends the one or more client characteristics of the respective client devices 108. The anomaly isolation module 102, in some embodiments, compares 514 the received one or more client characteristics of the set of abnormal clients (e.g., 108a-108b) with the received one or more client characteristics of the set of normal clients (e.g., 108c-108d). In some embodiments, anomaly isolation module 102 determines 516 one or more client-side anomalies based on the comparison.

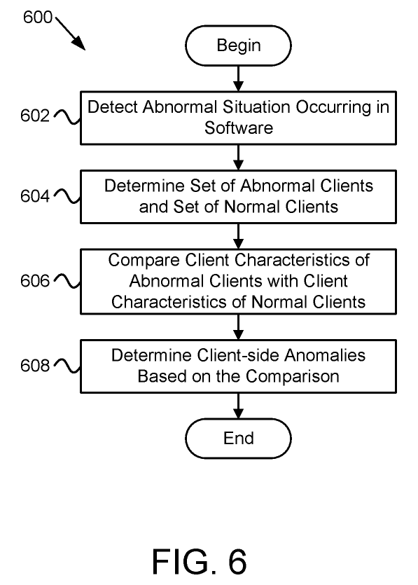

FIG. 6 is a schematic flow chart diagram illustrating a method 600 for detecting and isolating client application anomalies, according to various embodiments. The method 600 begins and detects 602 an abnormal situation occurring in the software. The method 600 determines 604 a set of abnormal clients (e.g., 108a-108b) and a set of normal clients (e.g., 108c-108d). The method 600 compares 606 one or more client characteristics of the set of abnormal clients (e.g., 108a-108b) with the one or more client characteristics of the set of normal clients (e.g., 108c-108d). The method 600 determines 608 one or more client-side anomalies based on the comparison.

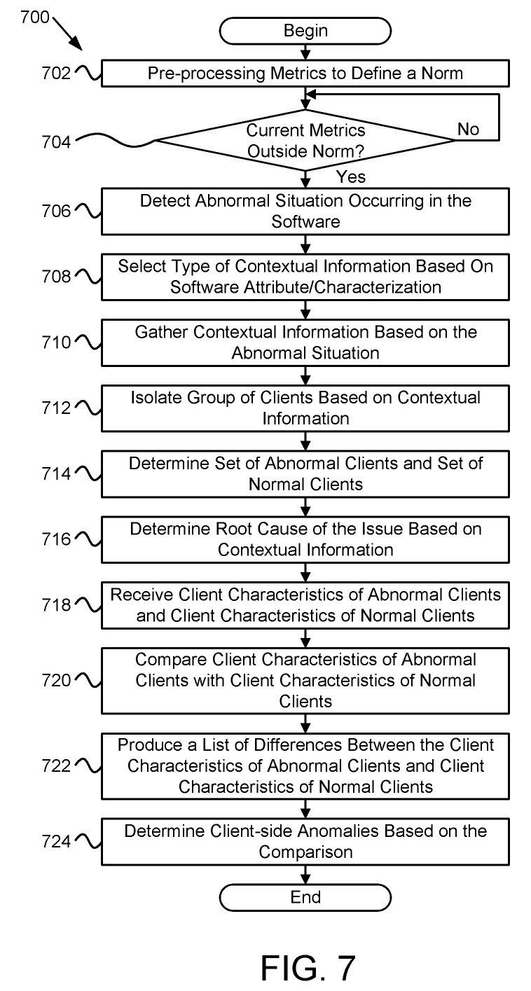

FIG. 7 is a schematic flow chart diagram illustrating a method 700 for detecting and isolating client application anomalies, according to various embodiments. The method 700 begins and pre-processes 702 one or more metrics to define a norm. The method 700 determines 704 if a currently measured one or more metrics are falling outside the norm. If the currently measured one or more metrics are not falling outside the norm, the method 700 returns and determines a next currently measured one or more metrics are falling outside the norm. If the currently measured one or more metrics are falling outside the norm, the method 700, detects 706 an abnormal situation occurring in the software.

The method 700, selects 708 a type of contextual information to be gathered based on a software attribute or software characterization. The method 700 gathers 710 contextual information based on the abnormal situation occurring in the software. The method 700, isolates 712 a group of clients (e.g., 108a-108d) based on the contextual information. The method 700, determines 714 a set of abnormal clients (e.g., 108a-108b) and a set of normal clients (e.g., 108c-108d) from the isolated group of clients (e.g., 108a-108d). The method 700, determines 716 a root cause of the issue based on the contextual information.

The method 700, receives 718 one or more client characteristics of the set of abnormal clients (e.g., 108a-108b) and the one or more characteristics of the set of normal clients (e.g., 108c-108d) and compares 720 the one or more client characteristics of the set of abnormal clients (e.g., 108a-108b) with the one or more client characteristics of the set of normal clients (e.g., 108c-108d). The method 700, produces 722 a list of differences between the one or more client characteristics of the set of abnormal clients (e.g., 108a-108b) and the one or more client characteristics of the set of normal clients (e.g., 108c-108d) and determines 724 client-side anomalies based on the comparison.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
detecting an abnormal situation occurring in a software;
determining, a set of abnormal clients and a set of normal clients in response to detecting the abnormal situation occurring in the software;
comparing one or more client characteristics of the set of abnormal clients with one or more client characteristics of the set of normal clients; and
determining one or more client-side anomalies based, at least in part, on the comparison.

2. The method of claim 1, further comprising:
pre-processing one or more metrics to define a norm; and
determining if a currently measured one or more metrics is falling outside the norm to detect the abnormal situation occurring in the software.

3. The method of claim 2, wherein pre-processing the one or more metrics comprises adjusting for seasonality in the one or more metrics and normalizing the one or more metrics.

4. The method of claim 1, further comprising:
gathering contextual information based on the abnormal situation in response to detecting the abnormal situation occurring in the software, the contextual information comprising information related to a respective client application;
isolating a group of clients based on the contextual information; and
determining, from the group of clients, the set of abnormal clients and the set of normal clients.

5. The method of claim 4, further comprising selecting one or more types of contextual information to be gathered based on a software attribute or a software characterization.

6. The method of claim 4, further comprising determining a root cause of the abnormal situation based on the contextual information.

7. The method of claim 4, wherein determining the set of abnormal clients comprises identifying, from the group of clients, a first set of clients which are experiencing an issue associated with the abnormal situation, and wherein determining the set of normal clients comprises identifying, from the group of clients, a second set of clients which are not experiencing the issue.

8. The method of claim 1, wherein determining the one or more client-side anomalies comprises producing a list of differences between the one or more client characteristics of the set of abnormal clients and the one or more client characteristics of the set of normal clients.

9. The method of claim 1, further comprising, in response to determining the set of abnormal clients and the set of normal clients, receiving the one or more client characteristics of the set of abnormal clients and the one or more client characteristics of the set of normal clients from the set of abnormal clients and the set of normal clients respectively.

10. The method of claim 9, further comprising, requesting the set of abnormal clients and the set of normal clients to send the one or more client characteristics of the set of abnormal clients and the one or more client characteristics of the set of normal clients respectively.

11. The method of claim 1, further comprising:
receiving the one or more client characteristics of the set of abnormal clients from the set of abnormal clients during the abnormal situation; and
selecting the one or more client characteristics of the set of normal clients based, at least in part, on a set of client characteristics associated with the set of normal clients, wherein the set of client characteristics were received during a previously known working situation and recorded in a normal log.

12. An apparatus comprising:
a processor; and
a non-transitory computer readable storage medium storing code, the code being executable by the processor to perform operations comprising:
detecting an abnormal situation occurring in a software;
determining, a set of abnormal clients and a set of normal clients in response to detecting the abnormal situation occurring in the software;
comparing one or more client characteristics of the set of abnormal clients with one or more client characteristics of the set of normal clients; and
determining one or more client-side anomalies based, at least in part, on the comparison.

13. The apparatus of claim 12, wherein the operations further comprise:
pre-processing one or more metrics to define a norm; and
determining if a currently measured one or more metrics is falling outside the norm to detect the abnormal situation occurring in the software.

14. The apparatus of claim 12, wherein the operations further comprise:
gathering contextual information based on the abnormal situation in response to detecting the abnormal situation occurring in the software, the contextual information comprising information related to a respective client application;
isolating a group of clients based on the contextual information; and
determining, from the group of clients, the set of abnormal clients and the set of normal clients.

15. The apparatus of claim 14, wherein the operations further comprise selecting one or more types of contextual information to be gathered based on a software attribute or a software characterization.

16. The apparatus of claim 14, wherein the operations further comprise determining a root cause of the abnormal situation based on the contextual information.

17. The apparatus of claim 14, wherein determining the set of abnormal clients comprises identifying, from the group of clients, a first set of clients which are experiencing an issue associated with the abnormal situation, and wherein determining the set of normal clients comprises identifying, from the group of clients, a second set of clients which are not experiencing the issue.

18. The apparatus of claim 12, wherein determining the one or more client-side anomalies comprises producing a list of differences between the one or more client characteristics of the set of abnormal clients and the one or more client characteristics of the set of normal clients.

19. The apparatus of claim 12, wherein the operations further comprise, in response to determining the set of abnormal clients and the set of normal clients, receiving the one or more client characteristics of the set of abnormal clients and the one or more client characteristics of the set of normal clients from the set of abnormal clients and the set of normal clients respectively.

20. A program product comprising a non-transitory computer readable storage medium storing code, the code being configured to be executable by a processor to perform operations comprising:
detecting an abnormal situation occurring in a software;
determining, a set of abnormal clients and a set of normal clients in response to detecting the abnormal situation occurring in the software;
comparing one or more client characteristics of the set of abnormal clients with one or more client characteristics of the set of normal clients; and
determining one or more client-side anomalies based, at least in part, on the comparison.
